(19) United States
(12) Patent Application Publication
(10) Pub. No.: US 2021/0400003 A1
(43) Pub. Date: Dec. 23, 2021

(54) SENDING MESSAGES TO ALL MEMBERS OR SELECTED MEMBERS OF A GROUP IN A MESSAGING APPLICATION BY STRING TAGGING AND CATEGORIZATION

(71) Applicant: Sarath KAKUMANU, Chennai (IN)

(72) Inventor: Sarath KAKUMANU, Chennai (IN)

(21) Appl. No.: 17/289,253

(22) PCT Filed: Sep. 28, 2019
(86) PCT No.: PCT/IN2019/050714

§ 371 Date: Apr. 28, 2021

(30) Foreign Application Priority Data
Nov. 1, 2018 (IN) 201841041387

(51) Int. Cl. H04L 12/58; G06Q 50/00

(52) U.S. Cl. CPC H04L 51/046; H04L 51/34; G06Q 50/01; H04L 51/16; H04L 51/24; H04L 51/12

(57) ABSTRACT

A system and method for sending messages to all members or selected members of a group in a structured messaging application thereby achieving masking/filters within the group members with respect to a message. The sending messages to all members or selected members of group module configured in association with a structured messaging application (Katchup application) for applying filters/mask with respect to a message to selected users in a messaging group. The sending messages to all members or selected members of a group module enables a sender to select preferred users within a messaging group to whom he would like to send a message and avoid other members from receiving the message.

### TECHNICAL FIELD

The present invention relates to information technology and computer applications. The present invention also relates to messaging applications for mobile communication devices which can be accessed from all types of communication devices like Smart phones, Desktop Computers, Laptop Computers and Digital Tablets. Further invention additional relates to structured messaging applications. The invention additionally relates to novel and user-friendly mechanism for string tagging and categorisation of group messages to apply filters/masks within the group members with respect to a message. Further, the present invention specifically relates to an improved system and method for sending messages to all members or selected members of a group in a messaging application by string tagging and categorization thereby achieving masking/filters within the group members with respect to a message.

### BACKGROUND OF THE INVENTION

Mobile communication devices, such as Mobile phones, iPhones, Android devices, are increasingly powerful and the sources of potential incoming messages are increasingly more varied. As a result, such mobile communication devices are being designed and built to permit users to accept various different heterogeneous messages. The inventor herein, who hails from a practical techno-industrial background, is proposing a very novel and innovative system and approach to handle group messages in a user friendly and convenient mechanism by proposing string tagging and categorisation technique for specific messages within the group. The idea of the inventor is bring in a new paradigm in the messaging applications industry where the solution proposed herein is going to change the perspective and approach of the messaging application industry altogether by addressing certain key challenges in the existing messaging application tools, such as, Whatsapp, Facebook Messenger, Google Hangout, WeChat, Telegram, Signal, IMO, Hike and so on.

Over-the-top (OTT) mobile messaging services and messaging apps, such as WhatsApp and Apple's iMessage, enable mobile messaging via an internet connection. Usage of OTT mobile messaging has already surpassed usage of SMS texting, largely due to the increasing use of mobile phones that have uninterrupted internet access. Other examples of OTT mobile messaging include WeChat®, Facebook® Messenger, Skype®, Kik™, GroupMe®, MessageMe™, and Snapchat®. Desktop and laptop computers, computer notebooks, and tablet computers having a touch display can also run desktop versions of these smart-phone-based mobile messaging apps. Such conventional messaging services offer group messaging using a group server, e.g. WhatsApp, Facebook, etc.

With the advent of modern mobile communication networks, group messaging services have gained a lot of popularity and hence reached wide adoption. Large groups (e.g. 15 people or more) generate a large number of messages and therefore users struggle to process and filter this huge amount of information, potentially missing relevant information due to this information overload.

However, such conventional mobile messaging services do not have an option to apply filters/masks where the sender can select specific members in the group where he/she may find that the other members do not have any stake in the intended message. In such instances, the sender may have to create a new group/sub-group with the selected members in his/her contact which can be a tedious and time consuming option for a user. It also fills up the application with too many groups which leads to unintended confusion in the communication.

Based on the foregoing, it is believed that a need exists for an improved structured messaging application for sending messages to all members or selected members of a group in a messaging application by string tagging and categorization which introduces a new and user-friendly messaging application paradigm for structured classification and representation of messages to the user on his/her communication device (Desktop/Laptop Computers, Digital Tablets and Moble Phones). The inventor has adapted a novel and user-friendly mechanism for addressing the challenges of the users in choosing intended recipients with respect to his/her messages in a group in a very user-friendly graphical user interface, as described in greater detail herein.

### SUMMARY OF THE INVENTION

The following summary is provided to facilitate an understanding of some of the innovative features unique to the disclosed embodiment and is not intended to be a full description.

It is, therefore, one aspect of the disclosed embodiments to provide for an improved structured messaging application for sending messages to all members or selected members of a group in a messaging application by string tagging and categorization for mobile as well as other communication devices like Desktop/Laptop Computer, Digital Tablets etc.

It is another aspect of the disclosed embodiments to provide for an improved novel and user-friendly mechanism for sending messages to all members or selected members of a group in a messaging application by string tagging and categorization with respect to a message.

It is a further aspect of the disclosed embodiments to provide for an improved system for sending messages to all members or selected members of a group in a messaging application by string tagging and categorization thereby achieving masking/filters within the group members with respect to a message.

The aforementioned aspects and other objectives and advantages can now be achieved as described herein. A system and method for sending messages to all members or selected members of a group in a messaging application by string tagging and categorization thereby achieving masking/filters within the group members with respect to a message, is disclosed herein. The sending messages to all members or selected members of a group in a messaging application by string tagging and categorization module configured in association with a structured messaging application (Katchup application) for applying filters/mask with respect to a message to selected users in a messaging group. The sending messages to all members or selected members module enables a sender to select preferred users within a messaging group to whom he/she would like to send a message and avoid other members from receiving the message. A messaging server (Katchup server in KPOST) for receiving, processing and sending messages to all members or selected members request from the messaging application to the intended contacts within the group.

The sending messages to all members or selected members of a group module also alerts the recipients in the group with the details of filters/masks which makes the recipient aware of the intended message share in the group and avoids confusion among the group members. The sending messages to all members or selected members of a group module therefore reduces the burden of creating new sub-groups and maintains simplified communication mechanism within the structured messaging application. For example, in a marketing group of an entity, if a member in the group needs to send a message to associates relating to a specific geography, the user may select to send messages to the intended associates alone by eliminating other unintended users in the same group.

The structured messaging application also permits the users to view the status of a sent message in the group and view status of the recipients in the group. The application also provides details of precise time on which the message was opened by the independent recipients in the group. The structured messaging application also permits the users to create a subject with respect to a message and also reply/clarify option for the users in the group where the entire sequence of communication is represented in a user friendly manner.

when one of the recipients in the selected members group replies, it will reach the ‘same selected group members’ and not all the members. Based on its type, the message also carries the tag ‘All Members’ or ‘Selected Members’.

The users (selected members or all members of the group) will always get the status of the messages irrespective of the receiver type—i.e. All members of a group or Selected members of a group. Whenever they open the message, they can view those who have opened the message and those who have not opened the message. If it is opened by somebody, then it will also show the time stamp.

### BRIEF DESCRIPTION OF THE DRAWINGS

FIG. 1 illustrates a graphical representation of the structured messaging application of sending messages to all members or selected members of a group module for achieving masking/filters within the group members with respect to a message, in accordance with the disclosed embodiments;

FIGS. 2 to 10 illustrates a graphical representation of the structured messaging application of sending message to all members of a group in accordance with the disclosed embodiments;

FIG. 11 to 21 illustrates a graphical representation of the structured messaging application of sending message to the selected members of a group in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of different features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

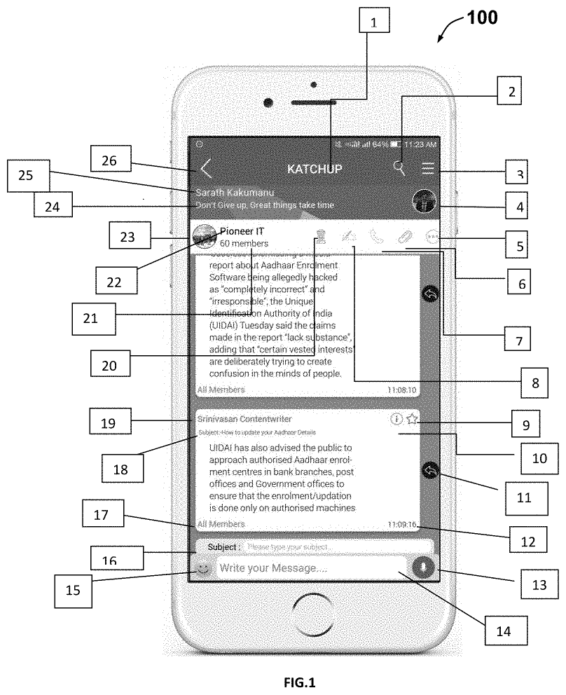

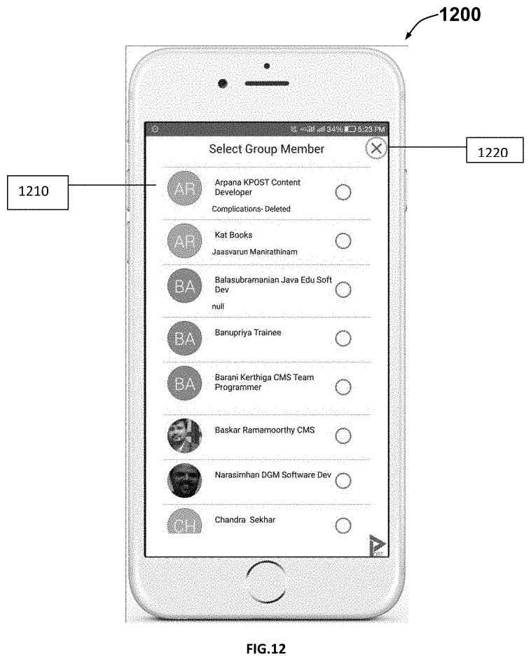

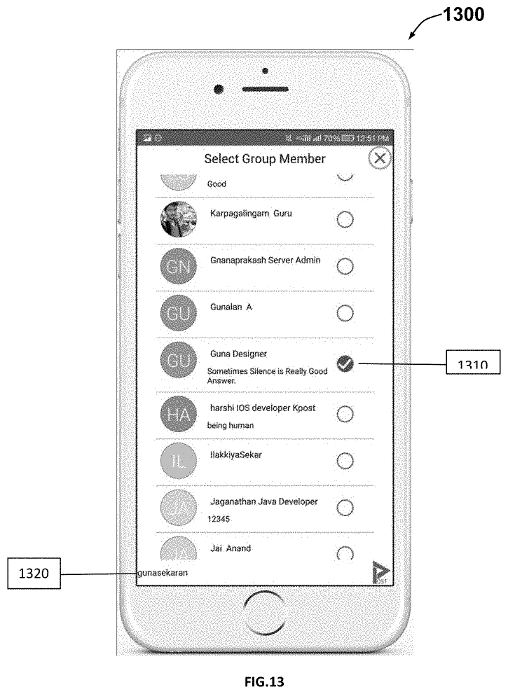

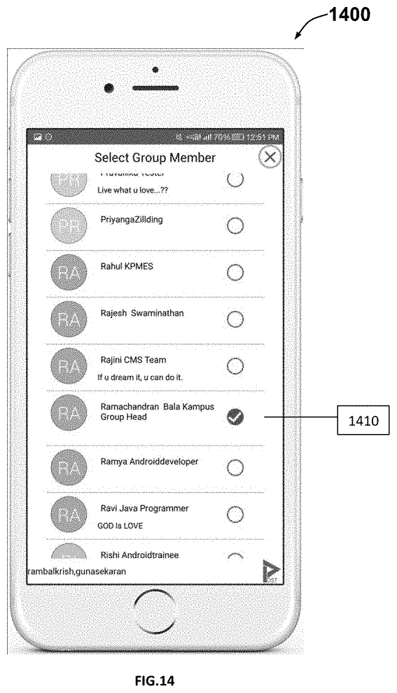

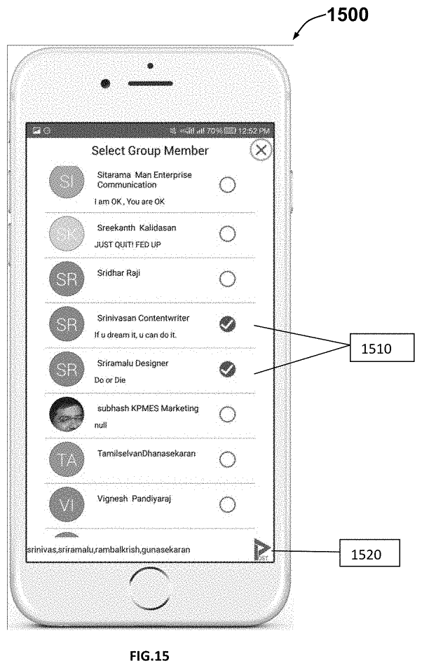

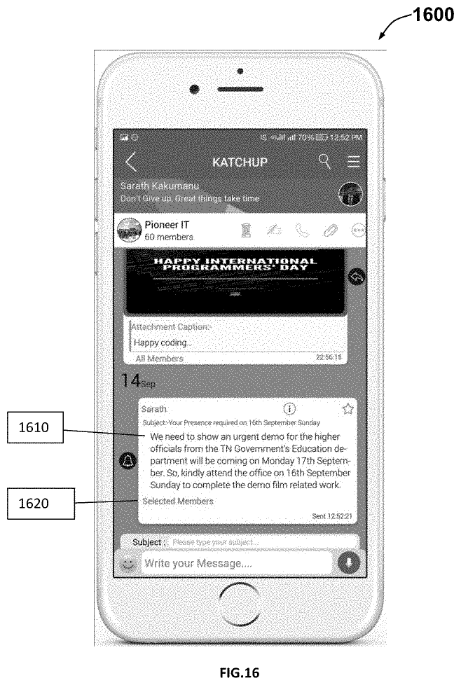

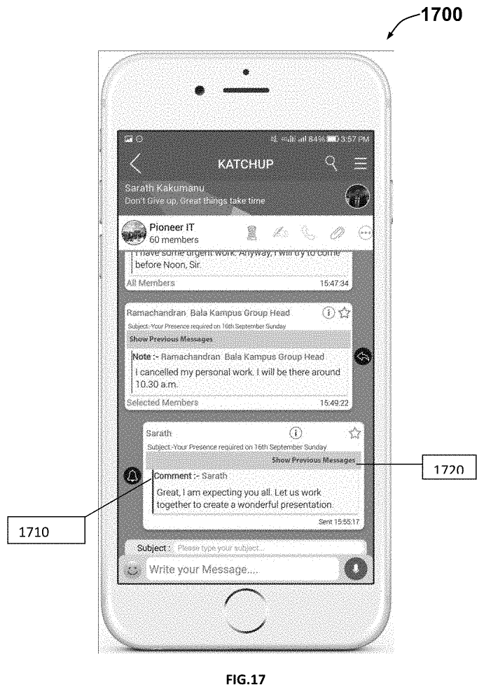

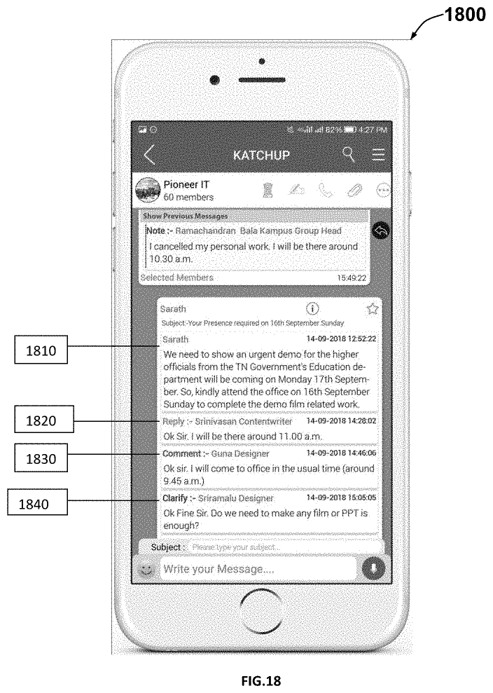

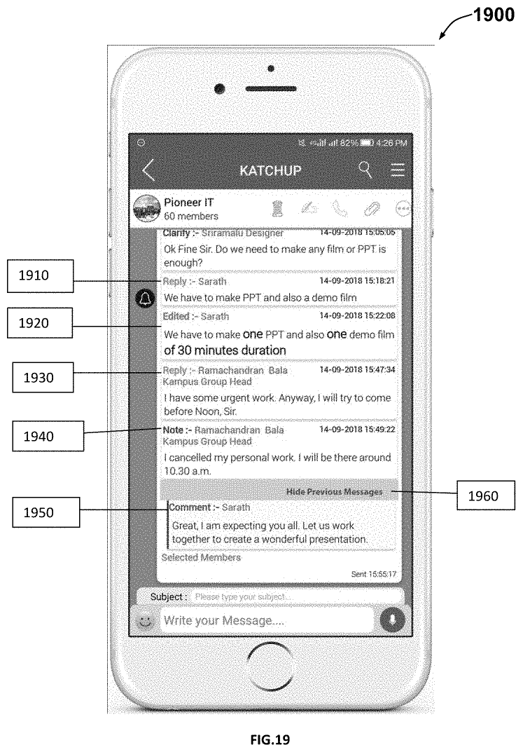

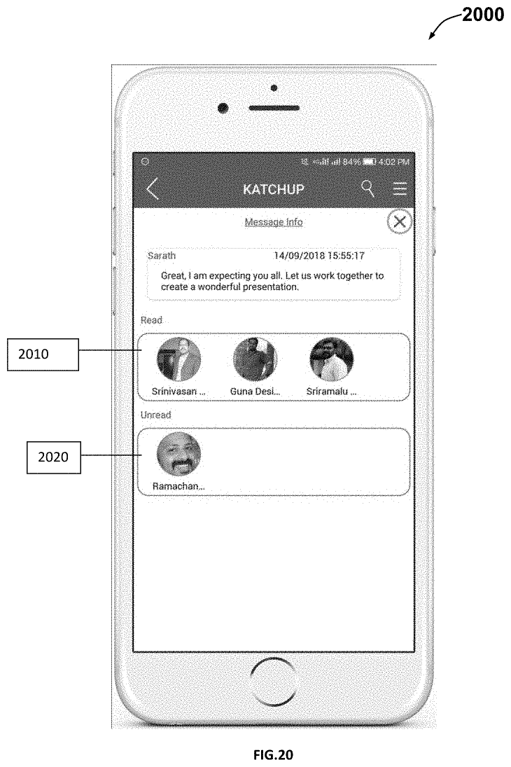

FIG. 1 illustrates a graphical representation of the structured messaging application (100) with sending messages to all members or selected members of group module (110) for achieving masking/filters within the group members with respect to a message, in accordance with the disclosed embodiments. The string tagging and categorisation module (110) configured in association with a structured messaging application (Katchup application) 100 for applying filters/mask with respect to a message to selected users in a messaging group. The sending messages to all members or selected members module 110 enables a sender to select preferred users within a messaging group to whom he would like to send a message and avoid other members from receiving the message, as illustrated in FIGS. 12-15.

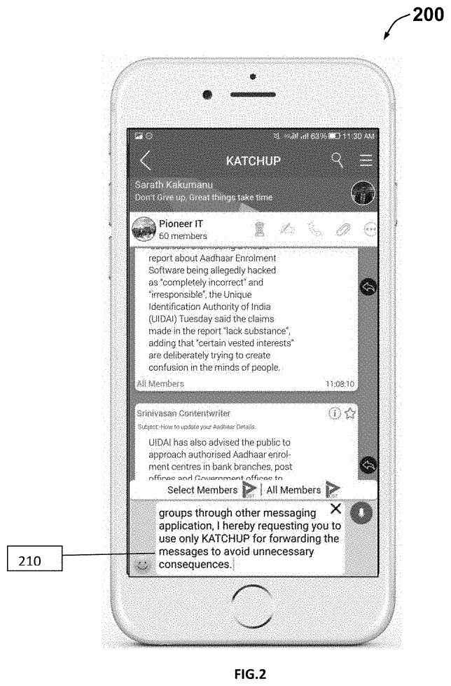

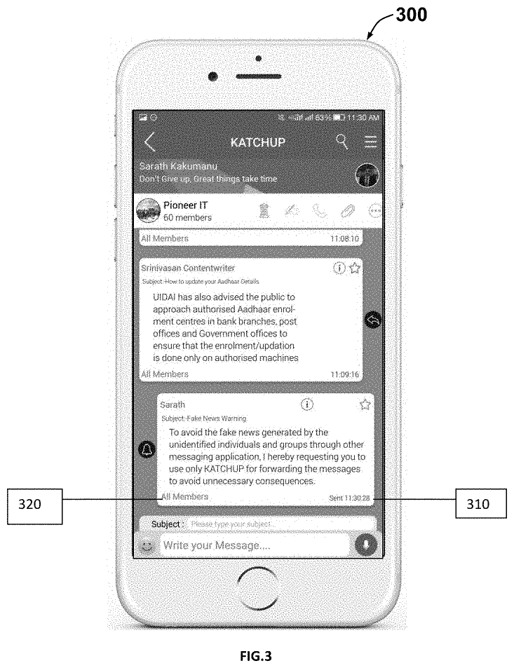

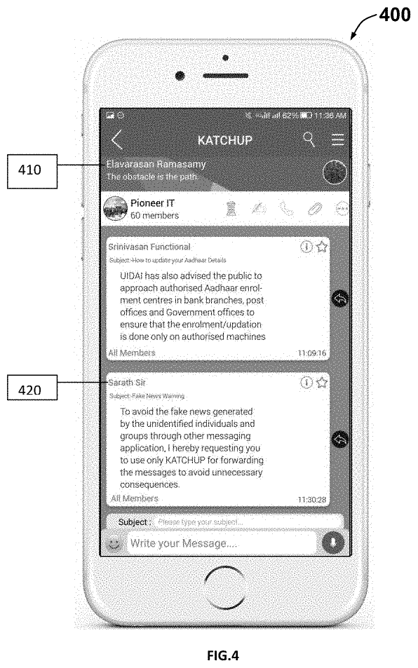

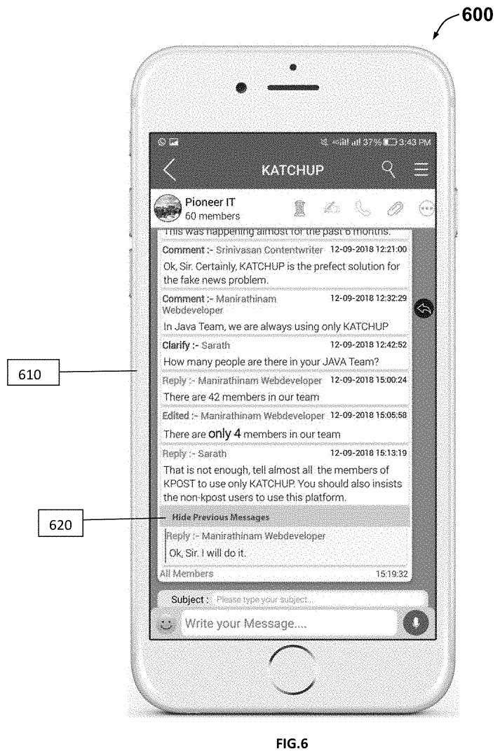

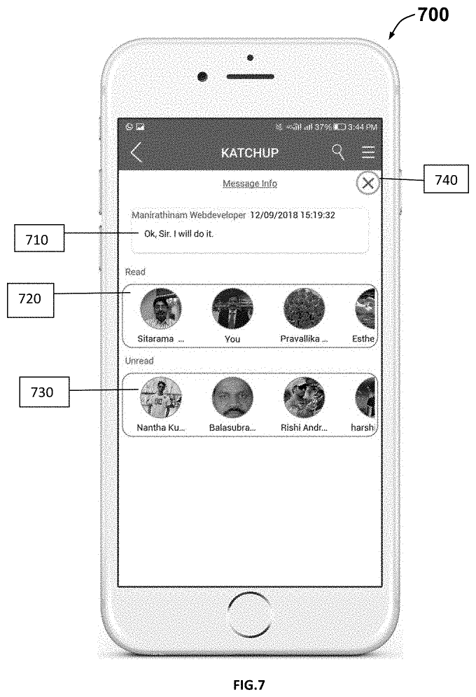

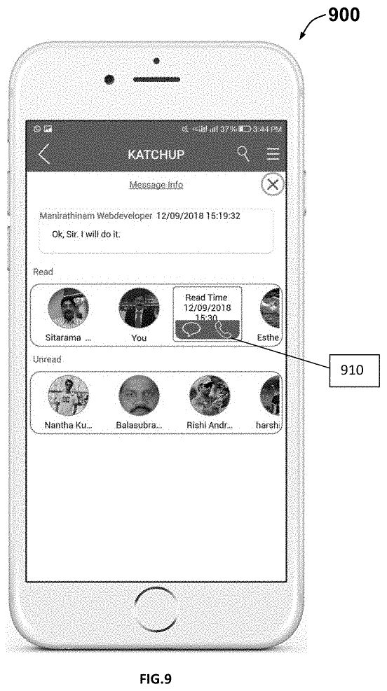

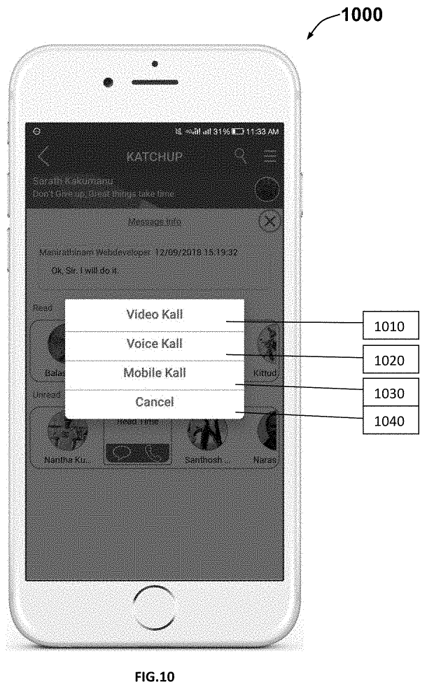

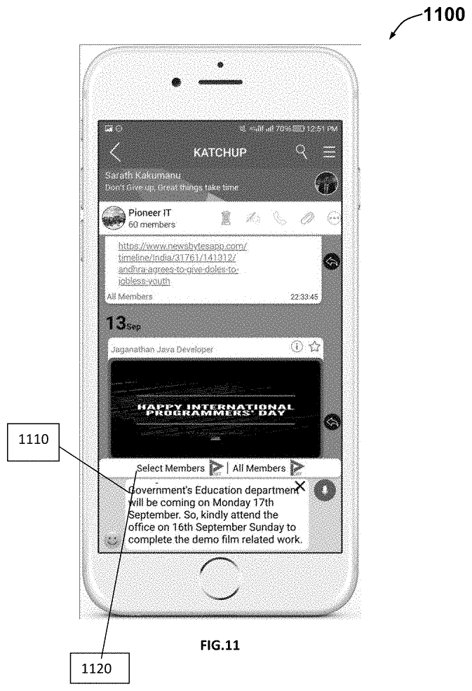

FIGS. 2-10 illustrate a graphical representation of various screens 200-1000 of the structured messaging application (Katchup application) illustrating various unique and novel features provided by string tagging and categorisation module for achieving masking/filters within the group members with respect to a message, in accordance with the disclosed embodiments. A messaging server (Katchup server) for receiving, processing and sending the string tagging and categorisation request from the messaging application to the intended contacts within the group. The sending messages to all members or selected members of a group module (110) also alerts the recipients in the group with the details of filters/masks which makes the recipient aware of the intended message share in the group and avoids confusion among the group members, as illustrated in FIG. 4. The sending messages to all members or selected members of a group module therefore reduce the burden of creating new sub-groups and maintains lean communication mechanism within the structured messaging application. For example, in a marketing group of an entity, if a member in the group would need to send a message to associates relating to a specific geography, the user may select to send messages to the intended associates alone by eliminating the junk messages to other unintended users in the same group.

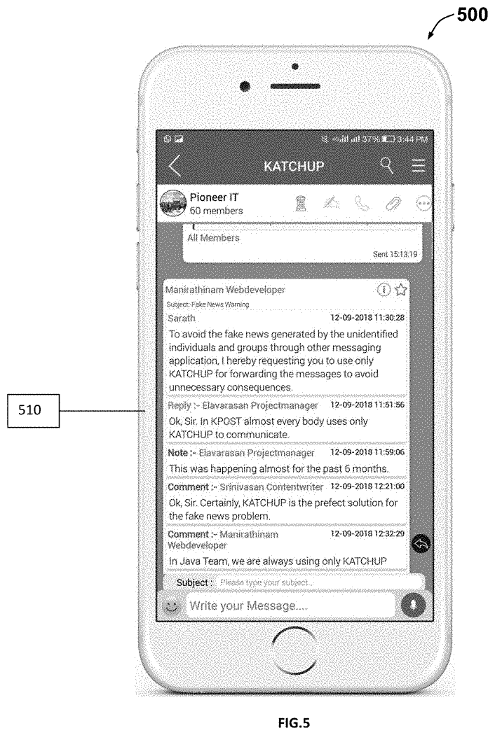

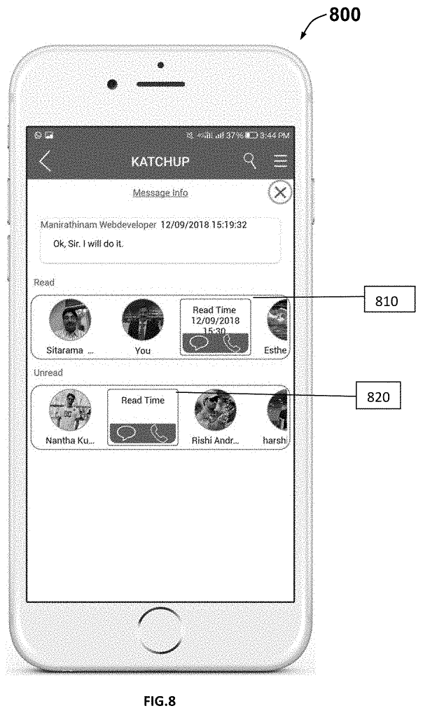

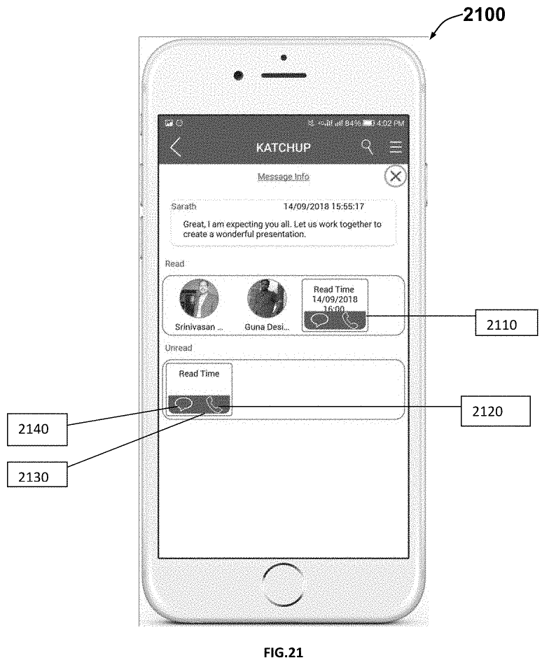

The structured messaging application 100 also permits the users to view the status of a sent message in the group and view status of the recipients in the group, as illustrated in FIG. 5. The application also provides details of precise time on which the message was opened by the independent recipients in the group, FIGS. 8 & 9 (for all members) and FIG. 21 (for selected members). The structured messaging application also permits the users to create a subject with respect to a message and also reply/clarify option for the users in the group where the entire sequence of communication is represented in a user friendly manner.

It will be appreciated that variations of the above-disclosed and other features and functions, or alternatives thereof, may be desirably combined into many other different systems or applications. Also unforeseen or unanticipated alternatives, modifications, variations or improvements therein may be subsequently made by those skilled in the art which are also intended to be encompassed by the following claims.

1. The system for sending message to all members or selected members of a group in a messaging application in a structured messaging application, said system comprising:
Sending message to all members or selected members of a group module configured in association with a structured messaging application (Katchup application) for applying filters/mask with respect to a message to selected users in a messaging group; and
a messaging server (Katchup server) for receiving, processing and sending the string tagging and categorisation request from the messaging application to the intended contacts within the group.

2. The system of claim 1 wherein sending message to all members or selected members of a group module provides masking/filters with respect to a message within the group members.

3. The system of claim 1 wherein the sending message to all members or selected members of a group module enables a sender to select preferred users within a messaging group to whom he would like to send a message and avoid other members from receiving the message.

4. The system of claim 1 wherein the sending message to all members or selected members of a group module alerts the recipients in the group with the details of filters/masks which makes the recipient aware of the intended message share in the group and avoids confusion among the group members.

5. The system of claim 1 wherein the structured messaging application permits the users to view the status of a sent message in the group and view status of the recipients in the group.

6. The system of claim 1 wherein the structured messaging application provides details of precise time on which the message was opened by the individual recipients in the group. And it can be seen by the sender as well as the recipients.

7. The system of claim 1 wherein the structured messaging application permits the users to create a subject with respect to a message and also reply/clarify option for the users in the group where the entire sequence of communication is represented in a user friendly manner.
